(19) United States
(12) Patent Application Publication
(10) Pub. No.: US 2025/0071063 A1
(43) Pub. Date: Feb. 27, 2025

(54) GLOBAL BANDWIDTH-AWARE ADAPTIVE ROUTING

(71) Applicant: MELLANOX TECHNOLOGIES, LTD., Yokneam (IL)

(72) Inventors: Wilson Kok, San Jose, CA (US); Barak Gafni, Sunnyvale, CA (US); Evgeny Tantsura, Palo Alto, CA (US); Suresh Kumar Jagadeesan, Bangalore (IN)

(21) Appl. No.: 18/377,642

(22) Filed: Oct. 6, 2023

(30) Foreign Application Priority Data
Aug. 25, 2023 (IN) 202311057144

(51) Int. Cl. H04L 47/125; H04L 45/12; H04L 45/28; H04L 45/52

(52) U.S. Cl. CPC H04L 47/125; H04L 45/123; H04L 45/28; H04L 45/52

(57) ABSTRACT

Systems and methods herein are for global bandwidth-aware adaptive routing in a network communication and include at least one switch to determine an event associated with a change in network bandwidth between a local host and a remote host, where the at least one switch is further to provide routing protocols for the network communication, and where the routing protocols is to be used to modify an adaptive routing in the at least one switch for selection from different routes for the network communication between the local host and the remote host.

### CROSS-REFERENCE TO RELATED APPLICATIONS

This application is related to and claims the benefit of priority from IN Patent Application No. 202311057144, filed on Aug. 25, 2023, the disclosure of which is incorporated by reference herein in its entirety for all intents and purposes.

### TECHNICAL FIELD

At least one embodiment pertains to Ethernet communications and particularly to global bandwidth-aware adaptive routing in Ethernet communications.

### BACKGROUND

Communication protocols may be provided for certain network communications, such as Ethernet, to enable standards for communication. In an example, such network communications can support artificial intelligence (AI) training workloads that require large east-west network bandwidth. Adaptive routing may be provided in the network communications to maximize network utilization by load balancing traffic based on local switch states such as queue length and port utilization. Further, AI training may include performance that is highly sensitive to changes in network conditions (including, to congestion, latency, drops). A failed link in the network may cause a reduction in bandwidth and potentially congestion, especially as AI related aspects in the network communications may operates at high utilization. Adaptive routing allows rebalancing decisions that may be based on local states and that may not enable upstream switches or routers to shift traffic away from downstream devices that are subject to events causing reduced bandwidth capacity, such as in cases of failed or congested links.

### BRIEF DESCRIPTION OF DRAWINGS

FIG. 1 illustrates a system that is subject to embodiments for global bandwidth-aware adaptive routing in Ethernet communications;

FIG. 2 illustrates aspects of a system for global bandwidth-aware adaptive routing in Ethernet communications, according to at least one embodiment;

FIG. 3 illustrates a topology associated with a system for global bandwidth-aware adaptive routing in Ethernet communications, according to at least one embodiment;

FIG. 4 illustrates computer and processor aspects of a system for global bandwidth-aware adaptive routing in Ethernet communications, according to at least one embodiment;

FIG. 5 illustrates a process flow in a system for global bandwidth-aware adaptive routing in Ethernet communications, according to at least one embodiment;

FIG. 6 illustrates yet another process flow in a system for global bandwidth-aware adaptive routing in Ethernet communications, according to at least one embodiment; and

FIG. 7 illustrates a further process flow in a system for global bandwidth-aware adaptive routing in Ethernet communications, according to at least one embodiment.

### DETAILED DESCRIPTION

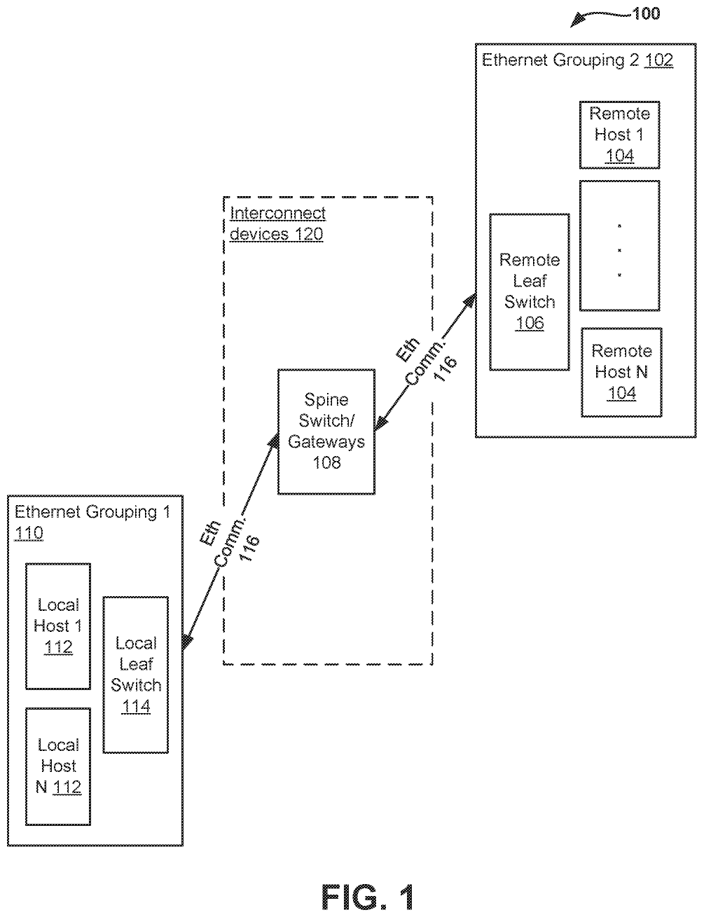

FIG. 1 illustrates a system 100 that is subject to embodiments for global bandwidth-aware adaptive routing in Ethernet communications, as detailed herein. The system 100 and a method for such a system 100 enables adaptive routing to rebalance transmission load distribution based on relative downstream capacity across multiple paths, indicated by events as they occur. This can result in optimal adjustments and reduced reliance on fabric-based flow control or endpoint-based congestion control. This ultimately minimizes performance impact with link failures in the fabric. For example, in a lossless fabric, congestion can trigger coarse grain flow control mechanisms such as, Per Priority Flow Control (PFC) which may cause head-of-line blocking or may cause a network spread across multiple hops. This can penalize unrelated traffic flows and can lead to significant performance degradation.

Further, endpoint-based congestion control provides mitigation by reducing the transmission rate to avoid congestion all together. The system 100 includes at least one circuit that may be an execution unit of a processor within a leaf switch 106; 114. The leaf switch 106; 114 may be associated with a respective one rack or other Ethernet grouping 2 102; 1 110 of hosts or other endpoints 1-N 104; 1-N 112, as illustrated. Further, the system 100 includes at least a spine switch or gateway 108, as part of one or more interconnect devices 120, to provide Ethernet communications 116 between multiple leaf switches 106, 114. As such, each Ethernet grouping 2 102; 1 110 of hosts or other endpoints 1-N 104; 1-N 112 may communicate within the grouping using the leaf switches and may communicate across groupings using spine switches or gateways 108. However, as endpoints may not have full knowledge of its associated network, such endpoint-based congestion control may over-correct to a lowest denominator among multiple routes or paths, in terms of available downstream capacity, and may cause over-reduction of overall performance.

In at least one embodiment, a system 100 for global bandwidth-aware adaptive routing in a network communication includes at least one switch, such as a leaf switch that is closest to a local host to determine an event associated with a change in network bandwidth between a local host and a remote host, representing separate endpoints in the network communication. For example, a remote leaf switch 106 that is closest to a failure or congestion link of a remote host 1-N 104 may have information associated with the failure or congestion link. The remote leaf switch 106 is downstream from a local host 112 and a local leaf switch LS1 114, and is able to communicate such information to a local leaf switch 114. The local leaf switch LS1 114 is able to provide routing protocols for the network communication, where the routing protocols can be used to modify an adaptive routing in the leaf switch for selection from different routes for the network communication between the local host and the remote host. In this manner, it is possible to account for changes in network bandwidth in a remote host that is downstream relative to the at least one switch and relative to the local host.

In at least one embodiment, a system includes one or more circuits to be associated with at least one switch. The one or more circuits are to determine an event associated with a change in network bandwidth between a local host and a remote host. The one or more circuits are further to provide routing protocols for the network communication. The routing protocols is to be used to modify an adaptive routing in the at least one switch for selection from different routes for the network communication between the local host and the remote host.

In at least one embodiment, a method for global bandwidth-aware adaptive routing in a network communication includes determining, using at least one switch, an event associated with a change in network bandwidth between a local host and a remote host. The method further includes modifying an adaptive routing in the at least one switch for selection from different routes for the network communication between the local host and the remote host. The method also includes providing routing protocols for the network communication to enable routing of communication between the local host and the remote host using one of the different routes that is based in part on the modification to the adaptive routing.

In at least one embodiment, such systems and method provide changes to adaptive routing as an algorithm that is otherwise unaware of downstream capacity by using downstream capacity information to augment adaptive routing decisions and to rebalance traffic based on the weights determined from the downstream capacity information. For example, in Border Gateway Protocol (BGP) for Ethernet communications, Weighted-Equal Cost Multipath (W-ECMP) link bandwidth extended community attribute may be used with a transitive propagation option, also referenced herein as routing protocol to modify aspects of an adaptive routing algorithm. This is such that when a link fails or a congestion event occurs within a fabric, a nearest router or switch (for example, within a predetermined hop distance from a local host associated with the event) sends advertisement or communication updates for affected routes and for next-hops with reduced bandwidth. In at least one embodiment, instead of BGP, any other protocol that has the capability of signaling relevant metadata, such as routing information, may embody the approaches herein for global bandwidth-aware adaptive routing in Ethernet communications.

In at least one embodiment, as a result, upstream routers or switches receiving the advertisements can determine different routes using updated relative weights in their respective adaptive routing algorithm. For example, an event may be converted to a weight, such as one of a lower, a neutral, or a higher weight, which may be used by a modification feature of the routing protocol to perform modification of the adaptive routing associated with the downstream traffic. This approach addresses failure or congestion events as they occur. An upstream router or switch's adaptive routing algorithm can cause distribution of traffic load according to the changed weights therein, which may be changed from the local states, such as queue length and port utilization. This enables avoidance of congestion and failure events by routing around such points in a network communication.

In at least one embodiment, a router or switch includes datapaths of different routes subject to selection as part of the adaptive routing algorithm therein, which can be modified using weights from the routing protocol so that the adaptive routing algorithm is both weight-aware and weight-unaware of any adaptive routing hardware. With weight-aware hardware, adaptive routing simply makes rebalancing decision based on the path weights. With weight-unaware hardware, calculations may be enabled by the routing protocols herein so that an amount of transmission capacity is reduced from lower weight paths. This can be achieved by removing next-hop interfaces (such as, for transmission purpose) towards lower weight neighbors from a next-hop group. Both such approaches reflect routing protocols to be used to modify an adaptive routing in the at least one switch for selection from different routes for the network communication between the local host and the remote host. Adaptive routing makes aware of global bandwidth to a remote or destination host and can derive an amount of traffic sent across members of an ECMP arrangement. The system herein uses an interface that is associated with at least one switch to receive instructions to enable the determination of the event associated with the change in network bandwidth and to enable a determination of the routing protocols for the network communication. Once an event is received in a communication associated with the remote host, at least one hop in a series of next-hops to the remote host may be removed, as part of the routing protocols, based in part on the communication to provide the modification of the adaptive routing in the at least one switch.

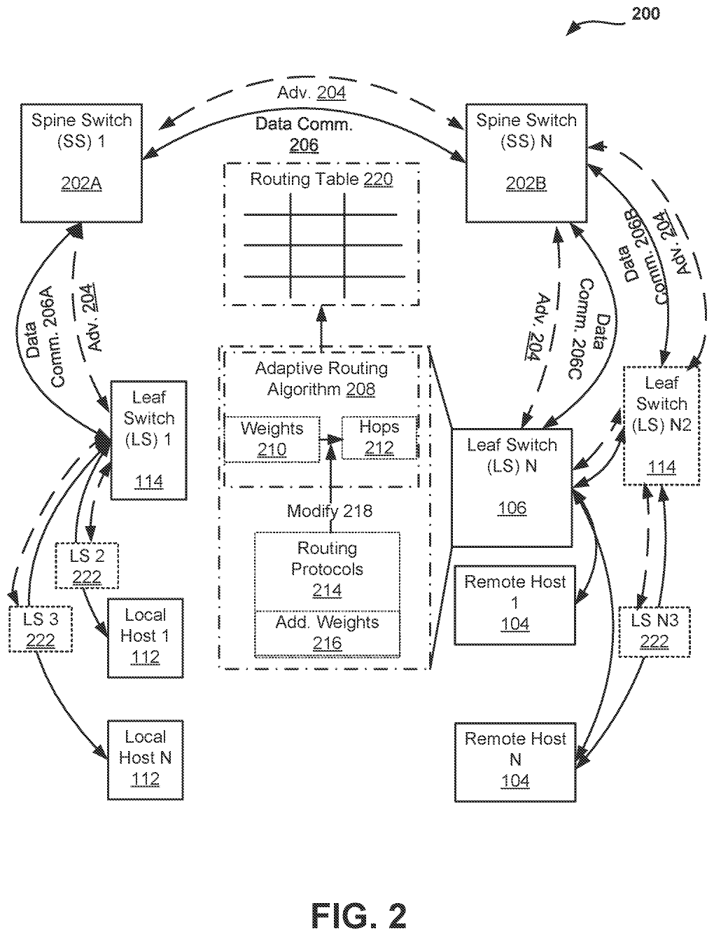

FIG. 2 illustrates aspects of a system 200 for global bandwidth-aware adaptive routing in Ethernet communications, according to at least one embodiment. The system 200 is subject, at least in part, to Border Gateway Protocol (BGP) that is used to determine best network routes for data communication links 206 using Ethernet. For example, switch or routers, including leaf switches and spine switches LSN 106, LS1 114, LSN2 114, SS1 202A, SSN 202B, can exchange routing information using advertisements 204 that are a specific type of configuration-based communication or messages about associated networks. This communication can include information about bandwidth associated with the networks. The leaf switches and spine switches LSN 106, LS1 114, LSN2 114, SS1 202A, SSN 202B capable of exchanging BGP or any other supported protocol's routing information may be referred to herein as peers or BGP peers. Therefore, these peers are not limited to BGP but may be in reference BGP or any other protocols having capability of signaling relevant meta-data for global bandwidth-aware adaptive routing in Ethernet communications.

Further, BGP may be considered as an exterior gateway protocol (EGP) that is used to exchange routing information among routers or switches that may be in different Ethernet groupings 1 110; 2 102. The routing information may include a complete route to each destination, such as, from a local host to a remote host. While BGP uses the routing information to prepare a routing table 220 and other tables associated with network reachability, it also enables switches or routers to exchange such information across the Ethernet groupings 1 110; 2 102. The BGP peers can, therefore, inform about routes between each other using the advertisements 204. For example, BGP peers can store routing tables 220 that may include routing information received from the advertisements 204, local routing information for local routes (such as not including a spine switch or gateway), and information that a BGP peer can advertise to other BGP peers in a separate advertisement. Further, the routing table 220 may be generated, in part, by an adaptive routing algorithm 208. The routing table 220 may be used by a routing process of the BGP peer to select a best or active route and may advertise this best or active route to other BGP peers. However, a BGP peer may be configured to advertise different routes to a same destination BGP peer or host.

A BGP peer that sends out a first advertisement for a route may assign the route one of different values to at least identify its origin and so that, during selection from one of different routes a lowest origin value may be selected. BGP also provides Equal Cost Multi-Path routing (ECMP) that uses multiple routes that may have similar or identical characteristics, such as, with reference to latency in the routes or with reference to link capacity. ECMP-based load-balancing for data communication links 206 may be enabled over different routes. Further, ECMP may be configured using an interface of a switch or router to allow up to 512 different routes for external BGP (EBGP) peers. As a result, a network may be scaled to increase a number of BGP peer connections a specified router or switch to improv latency and data flow.

In at least one embodiment, the advertisements 204 may include a BGP update. The BGP update may include a header; a listing of withdrawn routes, such as using internet protocol (IP) address prefixes associated with routes subject to being withdrawn from service or not reachable; infeasible route length of such withdrawn routes; route attributes, including a route origin, a multiple exit discriminator (MED), the origin's route preference, aggregation information, communities information, confederations information, and route reflection; network layer reachability information (NLRI), including those IP address prefixes of reachable routes being advertised; and a total route attribute length directed to route attributes for a reachable route to a destination BGP peer or host.

In at least one embodiment, weighted ECMP (or W-ECMP) herein can address a use of a bandwidth community attribute that is advertised as a reflection of the available capacity. For example, when one data communication link 206C between one spine switch SSN 202B and a leaf switch LSN 106 fails, representing a failure that is downstream from other leaf switches LS1-LSN2 114, LS2-LSN3 222 and a local host 1-N 112, these other leaf switches may receive a BGP update in an advertisement 204 with reduced weights for prefixes destined behind the leaf switch LSN 106 and for the next-hops till the spine switch SSN 202B at issue. Although illustrated as a direct coupling between each one spine switch SS1 202A, SSN 202B and a leaf switch LSN 106, there may be BGP peers, such as other routers or switches LS1-LSN2 114, LS2-LSN3 222 requiring the further hops between a local host and a remote host. The reduced weights for the prefixes destined behind leaf switch LSN 106 and for the next-hops till the spine switch SSN 202B (such as using another data communication link 206B) enable only the affected prefixes to experience a change in load distribution and can converge at predetermined capacity (such as, a ratio, 5/6^{th} of a total theoretical bandwidth).

Therefore, in at least embodiment, FIG. 2 illustrates a system 200 for global bandwidth-aware adaptive routing in a network communication using at least leaf switch LSN 106 to determine an event associated with a change in network bandwidth between a local host 1-N 112 and a remote host 1-N 104. The change may be a failure or a congestion event to one data communication link 206C. The at least leaf switch LSN 106 can provide routing protocols 214 for the network communication. The network communication can include the advertisements 204 sent from the at least one leaf switch LSN 106 to spine switches SS1 202A, LS1 114, LSN2 114, SSN 202B, LS2-N3 222 in the network. The routing protocols 214 can be used to modify 218 an adaptive routing, such as the adaptive routing algorithm 208, in the at least one switch LSN 106. The modification 218 is for selection from different routes, represented by different hops 212, for the network communication between the local host and the remote host. The different hops 212 enable the use of a different route, such as using a data communication link 206B from another leaf switch N2 114 to the spine switch SSN 202B.

In at least one embodiment, FIG. 2 also illustrates that the system 200 includes multiple links between each leaf switch LSN 106 to each spine switch SSN 202B, even though this is not illustrated for all leaf switches and for all spine switches. The system 200 is able to recognize an event as being a failed or congested data communication link 206C in at least one of different routes between the local host 1-N 112 and the remote host 1-N 104. Such a failed or congested data communication link 206C may be one of the links (the other being data communication link 206B) between a leaf switch LSN 106 and a spine switch SSN 202B. Further, the failed or congested link may cause the change in the network bandwidth between the local host and the remote host. For example, the network bandwidth may be monitored based at least in part on a comparison to pre-determined hop times used for monitoring data packets transmitted through the different routes. When a hop time for at least one link exceeds a pre-determined hop time, the link may be considered in an event of failure or congestion.

In at least one embodiment, the system 200 uses the routing protocols 214 with a BGP-enabled network that is enabled for communication of events, such as, routing information associated with the failed or congested data communication link 206C, between the at least one switch and other switches in the network communication. Further, the routing protocols 214 includes a conversion feature to convert the event from an advertisement 204 or from a monitored event to weighting values, such as the additional weights 216. The routing protocols 214 include a modification feature to be used to perform the modification 218 of the adaptive routing algorithm 208 using the weighting values.

In at least one embodiment, the modification 218 to the adaptive routing algorithm 208 includes additional weights 216 to a number of different hops 212 that provides different data communication links 206A-C for the network communication between the local host and the remote host. The additional weights may be incorporated in any manner suitable to the disclosure herein, including to normalize or ration part of the weights 210 of the adaptive routing algorithm 208. The weight change removes at least one of the next-hops so that at least the failure or congestion data communication link 206C may be bypassed. Instead, another data communication link 206B may be used. In at least one embodiment, at least one leaf switch LSN 106 includes an interface, such as command line interface (CLI), to receive instructions to enable the determination of the event associated with the change in network bandwidth and to enable a determination of the routing protocols 214 for the network communication. For example, an administrator of one part or an entire network can enable at least software and firmware changes to provide the W-ECMP approaches herein.

In at least one embodiment, the at least one leaf switch LSN 106 is within a predetermined hop distance from the remote host 1 104. For example, the leaf switch LSN 106 is the closest switch that is one hop from the remote host 1 104. The leaf switch LSN 106 includes an adaptive routing algorithm 208 to perform aspects described herein for the global bandwidth-aware adaptive routing in the network communication. Further, the at least one leaf switch LSN 106 is further able to receive the event in an advertisement 204 communication associated with the remote host, such as from the spine switch SSN 202B that is the highest grouping-related switch associated with multiple remote hosts 1-N 104. The at least one leaf switch LSN 106 is further able to remove at least one of the hops of a number of next-hops to the remote host. For example, the hops associated with the one leaf switch LSN 106 is enabled to be bypassed and, instead, a routing table 220 is updated by the adaptive routing algorithm 208 to include hops using a further leaf switch N2 114 to provide a different data communication link 206B, as part of the routing protocols. The further leaf switch N2 114 is also able to provide the different data communication link 206B based in part on the advertisements 204 communicated to the further leaf switch N2 114 to provide modification of its adaptive routing.

In at least one embodiment, therefore the system 200 includes one or more circuits to be associated with at least one leaf switch N 114. However, the one or more circuits may be across multiple switches enabled to perform the W-ECMP approaches herein. The one or more circuits may include at least an execution unit of a processor to determine an event associated with a change in network bandwidth between a local host and a remote host. The one or more circuits can provide routing protocols for the network communication so that the routing protocols can be used to modify an adaptive routing in the at least one switch for selection from different routes for the network communication between the local host and the remote host.

In at least one embodiment, Free Range Routing (FRR) may be used with W-ECMP approaches herein. FRR includes network routing software features to provide protocol daemons for BGP and can perform operations on Unix®-like platforms, including Linux®, Solaris®, OpenBSD®, FreeBSD®, and NetBSD®. Further, FRR in BGP can operate in multiple autonomous systems simultaneously with virtual routing and forwarding. In at least one embodiment, adaptive routing occurs in a transparent manner to the kernel of the operating system and to the FRR requirements.

In at least one embodiment, FRR provides a next hop group (NHG) to reach a determined prefix. The NHG is provided whenever there is a change in next-hop weights, such as a reduction and/or increase in weight for some of the next-hops. The FRR may be enabled as part of the routing protocols 214 to include a conversion feature to convert a community value of an advertisement 204, such as an incoming community value reflecting a downstream bandwidth event, into proportionated weight to provide the additional weight 216, among the W-ECMP members in such a way that a cumulative value of individual weights 210 is normalized to 100. The adaptive routing algorithm 208 can rely on the weight associated with individual neighbor or next hop groups and the available active next-hop links to derive the actual number of links to be changed, which reflects the modification 218 of an adaptive routing in the at least one switch for selection from different routes for the network communication between the local host and the remote host.

In at least one embodiment, a neighbor group is a grouping of different links between two or more switches. The neighbor group may be provided as a forwarding entity, such as a group of switches and routers, to enable rebalance of data communication towards a specific remote host that uses the grouping of different links and that uses a global identifier per switch in the different links. For example, to calculate an additional weights towards different peers, approaches herein account for all the next-hops, which may be more than one and which connect to the same peer. A determination of all the next-hops may be provided by a controller, which operates as a control plane of the network, such as a gateway or spine switch 108, in FIG. 1, herein. The controller provides all the next-hops to a forwarding entity, such as a switch or a router. Alternatively, the identification can be inferred by the forwarding entity from a next-hop attribute that is encoded with the global identifier, such as a next MAC address.

In at least one embodiment, grouping of next-hops into unique neighbor groups may be performed as part of the routing protocols 214. There may be multiple links connecting a particular leaf switch and one or more spine switches. The routing protocols 214 ensures that the neighborship (or grouping) information to decide which link(s) to remove is in an order to reduce a bandwidth capacity to a specific spine switch. For example, to identify all the next-hops connected to a specific BGP peer, an assignment of a same base-MAC (media access control) address to all of the adaptive routing (AR)-enabled ports in a BGP peer may be performed. There may be no change in behavior for the non-AR enabled ports which may include unique MAC addresses assigned for each of the non-AR enabled physical ports. Application programming interfaces (APIs) may be provided for setting the base-MAC. This approach ensures that all the next-hops having the same neighbor MAC would be termed as “neighbor-group” and implies that the next-hops belonging to the same neighbor-group are hosted from the same BGP peer.

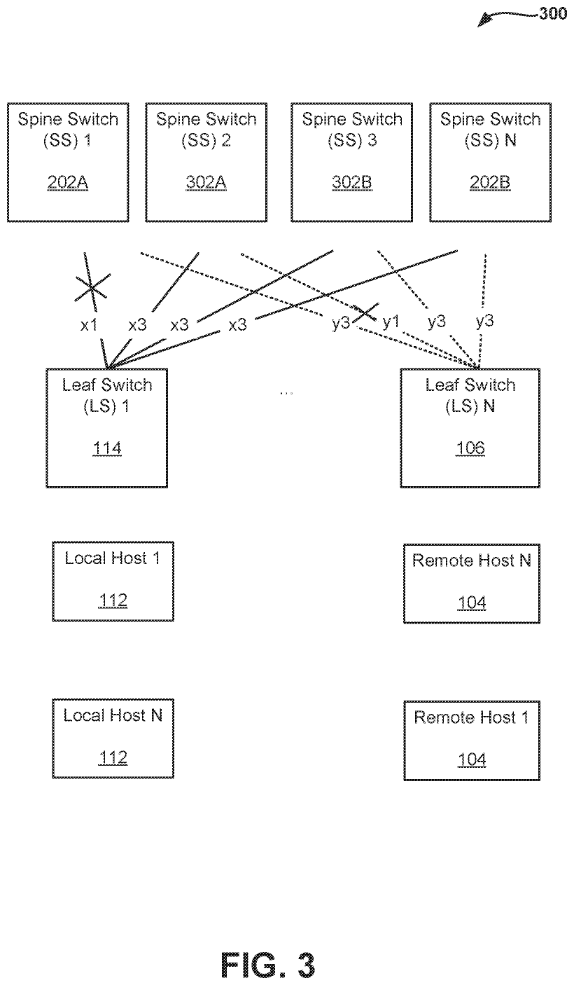

FIG. 3 illustrates a topology 300 associated with a system for global bandwidth-aware adaptive routing in Ethernet communications, according to at least one embodiment. In at least one embodiment, global bandwidth-aware adaptive routing may be provided an algorithm represented by the routing protocols 214. The routing protocols 214 may be applied under certain conditions and following procedures described with respect to FIG. 3. For example, the routing protocols 214 may be applied only if all the next-hops are to be provided over ports of switches capable of adaptive routing 208. In addition, the routing protocols 214 may be applied only if there are more than one next-hop in the NHG, only if there are more than one neighbor group in the NHG (where the neighbor group can be identified with a unique next-hop MAC), or only if there are next-hops with varying weights (such as, if all the next-hops have a same weight, then there may be no exclusions or modifications associated with the next-hops).

In at least one embodiment, when next-hops belong to a same neighbor group and include different weights, then routing protocols 214 need not perform exclusions to these next-hops as they represent an asymmetric topology. In at least one embodiment, the routing protocols 214 may be performed by a loop-through of all the next-hops to identify a next-hop and its associated neighbor group which has the highest weight (also referred to as a maximum weight, herein) among the other neighbor-group. Then, the routing protocols 214 can include an iteration process to iterate over each of the next-hops present in the NHG. In the iteration, if a particular neighbor group has only a single next-hop, then there may be no need to apply exclusions or modifications as described herein. Then, a next-hop may be added to the active next-hop list for an ECMP group.

In at least one embodiment, the routing protocols 214 includes that if a weight of a next-hop matches with the maximum weight then also there may be no need to apply the exclusions or modifications as described herein. Instead, all such next-hops may be added to the active next-hop list for the ECMP group. Further, the routing protocols 214 includes determining a weight reduction ratio. The weight reduction ratio may be determined for each neighbor group other than the one having the maximum weight. Derivation of the weight reduction ratio may be performed between the weight of a current neighbor group and that of a neighbor group that has maximum weight. For example, when one of a neighbor group's weight is 33 and a maximum weight is 66, then the ratio may be determined as 50%, 0.50, or 1/2). To derive the weight reduction ratio, a division of the neighbor group's weight by maximum weight may be performed.

In at least one embodiment, the routing protocols 214 includes determination of an actual number of next-hops to be excluded or modified based on the weight reduction ratio. This may be performed for each such neighbor group which has a different weight than the maximum weight. Further, the exclusion or modification of the number of next-hops may be based on the weight reduction ratio (as determined above) and may be based on a total number of next-hops available in the neighbor group. For example, for a weight reduction ratio of current neighbor group that is 25%, a reduction of the next-hop capacity of the neighbor group to one-fourth of total next-hop count may be needed. Further, if there are four next-hops available in a neighbor group, then exclusions or modifications may be performed to three of the next-hop so as to achieve the 75% capacity reduction. However, if there are only two next-hops available in the neighbor-group, then the exclusions or modifications would be only to a single link since the value of 75% of two available links is one. In addition, if the weight reduction ratio of a current neighbor group is 50%, then a reduction of the next-hop capacity to half may be required; and if there are two next-hops available in the neighbor group, then exclusions or modifications may be performed to one of the next-hop. Similarly, if there are four next-hops available, then exclusions or modifications may be performed to two out of the four next-hops so as to achieve a 50% capacity reduction; and if there are three next-hops available, then exclusions or modifications may be performed to only a single link out of the three next-hops.

In at least one embodiment, the routing protocols 214 includes if the ratio between the current neighbor group's weight and the weight of the neighbor group having a maximum weigh is 75%, then the next-hop capacity can be reduced to three-fourth of a total link capacity. When there are four next-hops available in the neighbor group, then exclusions or modifications may be performed to one of the next-hops so as to achieve the 25% capacity reduction. When a number of next-hops in the neighbor-group is two or three then then no need to perform exclusions or modifications to any links from the ECMP group as the resulting number of next-hops subject to such exclusions or modifications may not be present.

In at least one embodiment, therefore, a derivation of a number of next-hops to be subject to exclusions or modifications for each neighbor group may be based on the weight reduction ratio and the total number of next-hops available in the neighbor-group, given by (1−weight reduction ratio)×(no. of next-hops present in a neighbor group). In at least one embodiment, irrespective of the weight reduction ratio, at least one next-hop may be retained per neighbor group. Further, for any local link failure/recovery events, the routing protocols 214 herein may be repeated so that a weight-based link capacity reduction can consider a latest set of available links. A remaining number of next-hops may be added to the active next-hop list for the ECMP group and the ECMP group update may be applied to a software development kit (SDK) that is associated with the adaptive routing algorithm 208. In at least one embodiment, the link to be excluded towards a given spine may be selected by the modification 218 in a manner that is consistent across different instances of capacity reduction. This enables predictability in a system for global bandwidth-aware adaptive routing in Ethernet communications. As the next-hops may be stored in the NHG after sorting the next-hop based on port information for a switch, the routing protocols 214 herein allow selection of the first N next-hops to program into SDK out of M available next-hops (where N<M). As such, after installing the first N next-hops, the remaining (M−N) next-hops would be subject to the exclusions or modifications described throughout herein.

In the illustrated topology 300 that is subject to the routing protocols 214 described above, there are four spine switches SS1 202A, SSN 202B, SS2 302A, SS3 302B, with four leaf switches LS1 114, LSN 106 connected thereto using multiple links (reflected by marking “x3” for at least three available links) between each leaf switch LSN 106, LS1 114 and a spine switch SS1 202A; SSN 202B; SS2 302A; SS3 302B. When one link (reflected by marking “x1” of its three links), between a spine switch SS1 202A and a leaf switch LS1 114, fails or becomes congested, then all the other leaf switches (generally referenced by a leaf switch LSN 106) will see weight reduction on three paths (such as, out of the total twelve paths between each of the leaf switch and a spine switch, in one example) for a route prefix hosted behind the affected leaf switch LS1 114. For the leaf switch LS1 114, a steady state weight on each of the next-hops may be a value of “8.” This is so that a total weight may be adjusted to around “96” (determined by a multiplication of links and the weight, such as, 12×8).

In at least one embodiment, after a remote failure of one link that is downstream relative to a local host 112, such as, between a spine switch SS1 202A and a leaf switch LS1 114, an adjusted weight advertised from spine switches SS3-SSN towards the leaf switch LS1 114 would be, for example, a value of “9” (reflecting a higher weight) on each of their next-hops. Further, a weight advertised from spine switch SS1 202A towards a leaf switch LS1 114 would be “6” (reflecting a relative neutral weight, to the higher weight) for at least the three next-hops. This gives a total weight of around “99” (using a similar multiplication of links as provided above, (9×9)+(3×6)). While the FRR assigns a weight over the available next-hops based on an incoming link-bandwidth extended community part of a routing information, a total weight among the next-hops can be normalized to 100. In an example, a maximum weight attached to such a topology would be “9” and a weight reduction ratio, reflecting, in part, the modification 218 using additional weights 216, for the neighbor group of spine switch SS1 202A would be determined as “0.666667” (reflecting a weight reduction ratio of 6/9). This weight reduction ratio can apply to next-hops caused to be modified for a neighbor group associated with spine switch SS1 202A. That would provide a value of roughly “1” ((1−0.66666)×3). With this determination, the “1” value is in reference to one of the available links, from the neighbor group associated with spine switch SS1 202A, that would be modified, such as, by exclusion from the three available links.

In at least one embodiment, if there is a local failure of one link between spine switch SS1 202A and a leaf switch LS1 114, a further NHG update may be advertised so that newer weights may be provided to modify the adaptive routing. The newer weights may be advertised from spine switches SS2 302A, SSN 302B, SSN 202B towards the leaf switch LS1 114 and could be a value, such as “10” on each of their next-hops, whereas newer weight advertised from spine switch SS1 202A towards a leaf switch LS1 114 would be “5” for two of remaining next-hops. This is so that a total weight may be determined to be around “100” (provided by (9×10)+(2×5)). With a local failure occurring, along with a remote failure, a maximum weight value used may be “10” and a weight reduction ratio for a neighbor group of spine switch SS1 202A would be determined as “5” (from a weight reduction ratio of 5/10), and since “5” is a weight for a neighbor group associated with the spine switch SS1 202A. The number of next-hops to be excluded for the neighbor group would be one (determined by 1×0.5)×2). With this determination, one of the links from the neighbor group would be excluded of the two available links, reflecting a modification of an adaptive routing in at least one switch for selection from different routes for the network communication between the local host and the remote host.

In at least one embodiment, a topology 300 may include four spine switches SS1 202A, SSN 202B, SS2 302A, SS3 302B, with leaf switches LS1 114, LSN 106 connected there to using multiple links (reflected by marking x3 for at least three available links) between each leaf switch LS1 106, LSN 114 and a spine switch SS1 202A; SSN 202B; SS2 302A; SS3 302B. A leaf switch LS1 114 is in a steady state weight that is advertised for a prefix including the leaf switch LS1 114, from another leaf switch LSN 106. For example, the steady state weight of next-hops may be “8”, so that a total weight may be determined as about 96. In case of a link failure of two links (referenced by “y1”) between spine switch SS2 302A and leaf switch LSN 106, there may be only a single link connecting these two switches. On leaf switch LS1 114, a weight over each of the nine next-hops for the remaining spine switches SS1 202A, SSN 202B, and SS3 302B, may be around “10” and the weight advertised from the three next-hops for the spine switch at issue (spine switch SS2 302A) may be “3”. This is so that a total weight may be determined as around “99.” In this case, a maximum weight assigned would be around “10” and a weight reduction ratio for the neighbor group of the spine switch at issue (spine switch SS2 302A) would be 0.3 (determined from 3/10). As a result, a number of next-hops to be excluded for a neighbor group associated with the switch at issue (spine switch SS2 302A) would be two (determined by (1−0.3)×3). With this calculation, two links from a neighbor group for spine switch SS2 302A would be excluded out of the three available links, which also reflects a modification of an adaptive routing in at least one switch for selection from different routes for the network communication between the local host and the remote host.

In at least one embodiment, if, along with the link failure on a leaf switch LSN 106, there is another failure of a set of links between leaf switch LS1 114 and a spine switch SS1 202A, a single remaining link may exist for this leaf switch and spine switch combination. As a result, on leaf switch LS1 114, a weight over each of six next-hops for the remaining spine switches SSN 202B, SS2 302A, SS3 302B may be around “12,” whereas a weight advertised over lone remaining next-hop for the spine switch SS1 202A would be “12” and a weight advertised from the three next-hops for spine switch SS2 302A may be provided as “4” (reflecting a lower weight relative to the neutral weight and the higher weight). A total weight from such weight modifications may be determined as 96 (determined by (6×12)+(1×12)+(3×4)). As such, in this case, a maximum weight may be determined to be “12” and a weight reduction ratio for the neighbor group that is associated with spine switch SS2 302A may be a value of 0.33 (determined by a weight reduction ratio of 4/12), where “4” is the weight for the neighbor group of spine switch SS2 302A. Then, a number of next-hops to be excluded for the neighbor group associated with spine switch SS2 302A would be 2 (determined by (1−0.333)×3). With this determination, two links from the neighbor group associated with spine switch SS2 302A would be excluded out of the three available links. Further, as a weight for a neighbor group associated with spine switch SS1 202A is same as a maximum weight, there may be no need to exclude any links towards spine switch SS1 202A.

While these weight determinations enable routing protocols herein by a conversion feature to convert events to weighting values and by a modification feature to be used to perform the modification of the adaptive routing using the weighting values, there are merely exemplary and non-limiting. The routing protocols are used to modify an adaptive routing, as supported in part using the examples in FIGS. 1-3, in the at least one switch for selection from different routes for the network communication between the local host and the remote host. The selection may be enabled within leaf switches or spine switches or a combination thereof based in part on determination made in at least one of such leaf switches or spine switches that may be nearest to a failed or congested link that may be downstream (reflecting a remote location) relative to a local host machine.

In at least one embodiment, AR load balancing can be applied on underlay packets destined for the remote virtual tunnel endpoints (VTEPs). For example, W-ECMP can be configured on an underlay prefixes (such as, using VTEP addresses) such that adaptive routing-based traffic for load-balancing can be applied on the underlay packets. For example, for Virtual Extensible LAN (VXLAN), encapsulated packets may be destined from one VTEP to another VTEP. Even if W-ECMP is enabled on the overlay prefixes, AR load-balancing need not be applied. However, W-ECMP load-balancing may be applied. Therefore, adaptive routing, as used herein, is in reference to adaptive or provided routing so long as routing table associated with next-hops is provided and which is subject to modification using the routing protocols herein.

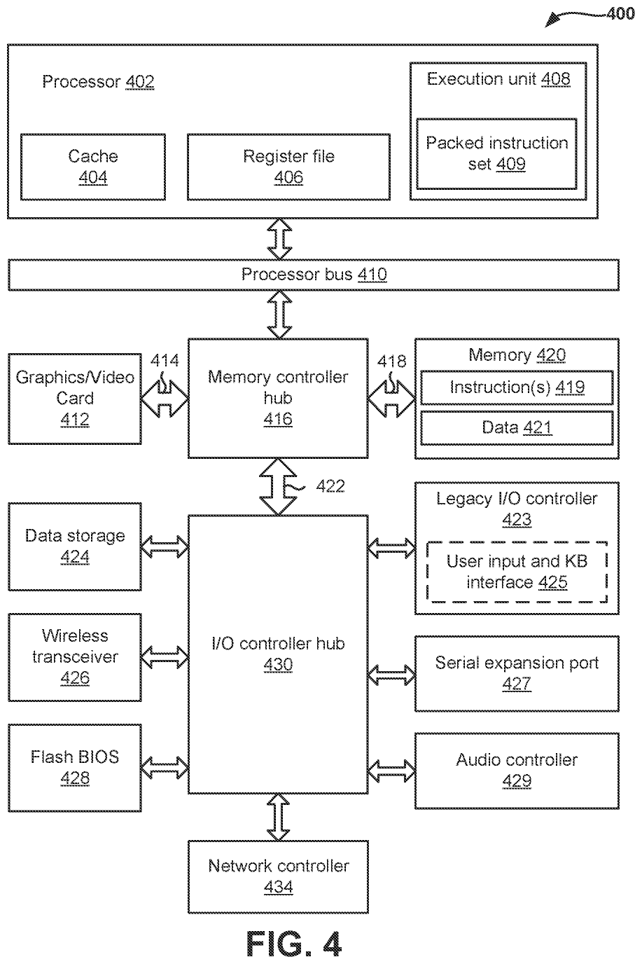

FIG. 4 illustrates computer and processor aspects 400 of a system for global bandwidth-aware adaptive routing in Ethernet communications 116, according to at least one embodiment. The computer and processor aspects 400 may be performed by one or more processors that include a system-on-a-chip (SOC) or some combination thereof formed with a processor that may include execution units to execute an instruction, according to at least one embodiment. Such one or more processors may include CPUs, DPUs, and GPUs and may be within one of such leaf switches or spine switches described all throughout herein. Further, the computer and processor aspects may be within one or more of the Ethernet hosts 1-N 104, 1-N 112, or the Ethernet/Interconnect devices 106, 108, 114, 120.

In at least one embodiment, the computer and processor aspects 400 may include, without limitation, a component, such as a processor 402 to employ execution units including logic to perform algorithms for process data, in accordance with present disclosure, such as in embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS® operating system available from Microsoft® Corporation of Redmond, Wash., although other operating systems (UNIX® and Linux®, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one: embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1-3 and 5-7 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processor 402 and other components in computer and processor aspects 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache 404 may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processor 402 may communicate with MCH 416 via processor bus 410. In at least one embodiment, an MCH 416 may provide a high bandwidth memory path 418 to a memory 420 for instruction and data storage and for storage of graphics commands, data and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processor 402. Examples may include, without limitation, an audio controller 429, a firmware hub (“flash BIOS”) 428, a wireless transceiver 426, a data storage 424, a legacy I/O controller 423 containing user input and keyboard interfaces 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe®) or some combination thereof. In at least one embodiment, one or more components of the computer and processor aspects 400 that are interconnected using compute express link (CXL) interconnects.

In at least one embodiment, the system in FIGS. 1-4 therefore include one or more execution units 408 in the Ethernet hosts 1-N 104, 1-N 112, or the Ethernet/Interconnect devices 106, 108, 114, 120 to support global bandwidth-aware adaptive routing in Ethernet communications. For example, at least one execution unit 408 of one host machine or of one Ethernet/Interconnect device supports communication to other processing units of the other host machines or of other Ethernet/Interconnect devices using global bandwidth-aware adaptive routing. The at least one execution unit 408 is further to determine an event associated with a change in network bandwidth between a local host and a remote host. The at least one execution unit 408 is further to provide routing protocols for the network communication. The routing protocols can be used to modify an adaptive routing in the at least one switch for selection from different routes for the network communication between the local host and the remote host.

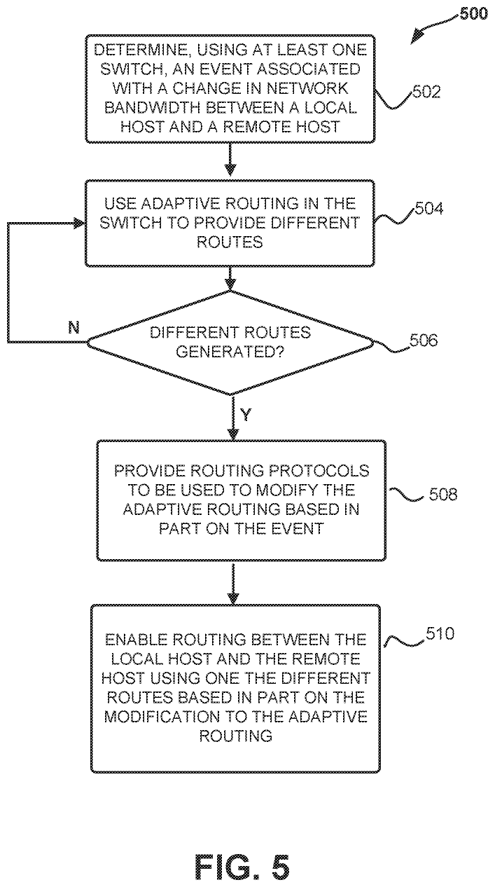

FIG. 5 illustrates a process flow or method 500 in a system of FIGS. 1-4 for global bandwidth-aware adaptive routing in Ethernet communications, according to at least one embodiment. The method 500 includes determining 502, using at least one switch, an event associated with a change in network bandwidth between a local host and a remote host. The method 500 may include the use 504 of adaptive routing in the at least one switch to provide a routing table of different routes and which is subject to modification by the event. For example, the method 500 includes determining 506 that the different routes are generated, where the different routes may be represented by hops or next-hops associated with neighbor groups. The method 500 includes providing 508 routing protocols that are to be used to modify an adaptive routing based in part on the event. The method 500 includes enabling 510 routing between the local host and the remote host using one of the different routes between the local host and the remote host. In step 510, the routing is based in part on the modification to the adaptive routing to select the one of the different routes.

In at least one embodiment, the method 500 is such that the event is a failed or congested link in the different routes between the local host and the remote host. Further, the failed or congested link can cause the change in the network bandwidth between the local host and the remote host. The method 500 includes the routing protocols being associated with a BGP that enables communication of the event between the at least one switch and other switches in the network communication, using advertising communications, for example.

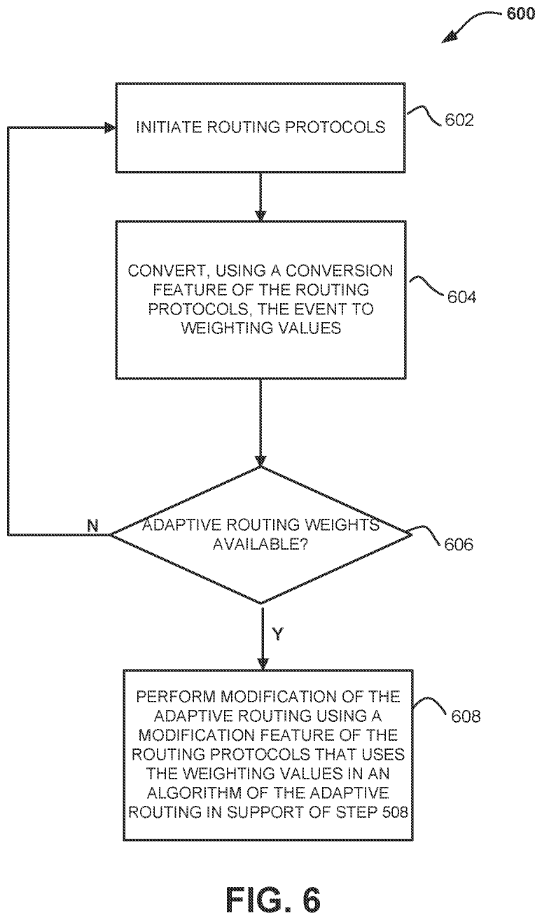

FIG. 6 illustrates yet another process flow or method 600 in a system for global bandwidth-aware adaptive routing in Ethernet communications, according to at least one embodiment. The method 600 may be in support of the method 500 in FIG. 5. For example, the method 600 includes initiating 602 routing protocols in a supported switch or router. The method 600 includes converting 604, using a conversion feature of the routing protocol, the event to weighting values. Adaptive routing weights from an algorithm associated with adaptive routing may be retrieved, such as from (or associated with a routing table). The method 600 includes verifying 606 that the adaptive routing weights are available. The method 600 includes performing 608 modification of the adaptive routing using a modification feature of the routing protocols that uses the weighting values in the algorithm associated with the adaptive routing. Step 608 may be in support of step 508 in FIG. 5

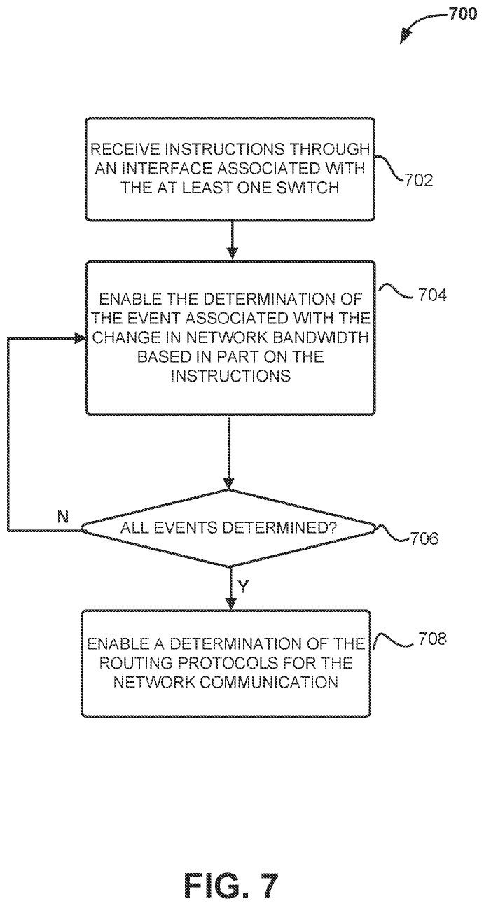

FIG. 7 illustrates a further process flow or method 700 in a system for global bandwidth-aware adaptive routing in Ethernet communications, according to at least one embodiment. The method 700 may be in support of one or more of the method 500 in FIG. 5 or the method 600 in FIG. 6. For example, the method 700 includes receiving 702 instructions through an interface associated with the at least one switch. The method 700 includes enabling 704 the determination (as in step 502) of the event associated with the change in network bandwidth based in part on the instructions. There may be multiple events as explained in the example topology of FIG. 3. Therefore, a verification 706 can be made that all events are determined so that all events are converted 604 to appropriate weighting values. The method 700 includes enabling 708 a determination of the routing protocols for the network communication. For example, different ones of the routing protocols may address different events in a network communication, such as failure of links towards leaf switches, towards spine switches, or congestion events. As such, appropriate routing protocols may be determined to apply appropriate weighting values as ratios, for instance, to change neighbor groups, as described in connection with at least FIG. 3.

In at least one embodiment, the methods herein include determining the at least one switch, to perform such modification in step 508, based in part on a predetermined hop distance from the remote host. The at least one switch is adapted to perform an adaptive routing algorithm and is able to perform the modification using the routing protocols corresponding to W-ECMP herein. The methods herein include receiving the event in a communication to the at least one switch from the remote host and removing at least one hop of provided next-hops from an adaptive routing, where the next-hops is at least between the remote host and the location host. The removal is part of the routing protocols and is based in part on the communication to provide the modification of the adaptive routing in the at least one switch.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system for global bandwidth-aware adaptive routing in a network communication, comprising:
at least one switch to determine an event associated with a change in network bandwidth between a local host and a remote host and to provide routing protocols for the network communication, the routing protocols to be used to modify an adaptive routing in the at least one switch for selection from different routes for the network communication between the local host and the remote host.

2. The system of claim 1, wherein the event is failed or congested link in the different routes between the local host and the remote host, the failed or congested link to cause the change in the network bandwidth between the local host and the remote host.

3. The system of claim 1, wherein the routing protocols is associated with a Border Gateway Protocol (BGP) that enables communication of the event between the at least one switch and other switches in the network communication.

4. The system of claim 1, wherein the routing protocols comprises a conversion feature to convert the event to weighting values and comprises a modification feature to be used to perform the modification of the adaptive routing using the weighting values.

5. The system of claim 1, wherein the modification to the adaptive routing comprises a weight change to a plurality of next-hops providing the different routes for the network communication between the local host and the remote host, wherein the weight change removes at least one of the plurality of next-hops.

6. The system of claim 1, wherein the at least one switch comprises an interface to receive instructions to enable the determination of the event associated with the change in network bandwidth and to enable a determination of the routing protocols for the network communication.

7. The system of claim 1, wherein the at least one switch is within a predetermined hop distance from the remote host and comprises an adaptive routing algorithm, the at least one switch further to:
receive the event in a communication associated with the remote host; and
remove at least one of a plurality of next-hops to the remote host, as part of the routing protocols, based in part on the communication to provide the modification of the adaptive routing in the at least one switch.

8. A system comprising:
one or more circuits to be associated with at least one switch, to determine an event associated with a change in network bandwidth between a local host and a remote host, and to provide routing protocols for the network communication, the routing protocols to be used to modify an adaptive routing in the at least one switch for selection from different routes for the network communication between the local host and the remote host.

9. The system of claim 8, wherein the event is failed or congested link in the different routes between the local host and the remote host, the failed or congested link to cause the change in the network bandwidth between the local host and the remote host.

10. The system of claim 8, wherein the routing protocols is associated with a Border Gateway Protocol (BGP) that enables communication of the event between the at least one switch and other switches in the network communication.

11. The system of claim 8, wherein the routing protocols comprises a conversion feature to convert the event to weighting values and comprises a modification feature to be used to perform the modification of the adaptive routing using the weighting values.

12. The system of claim 8, wherein the modification to the adaptive routing comprises a weight change to a plurality of next-hops providing the different routes for the network communication between the local host and the remote host, wherein the weight change removes at least one of the plurality of next-hops.

13. The system of claim 8, wherein the one or more circuits is further to:
receive instructions to enable the determination of the event associated with the change in network bandwidth and to enable a determination of the routing protocols for the network communication.

14. The system of claim 8, wherein the at least one switch is within a predetermined hop distance from the remote host and comprises an adaptive routing algorithm, the one or more circuits further to:
receive the event in a communication associated with the remote host; and
remove at least one of a plurality of next-hops to the remote host, as part of the routing protocols, based in part on the communication to provide the modification of the adaptive routing.

15. A method for global bandwidth-aware adaptive routing in a network communication, comprising:
determining, using at least one switch, an event associated with a change in network bandwidth between a local host and a remote host;
providing routing protocols to be used to modify an adaptive routing based in part on the event; and
enabling routing between the local host and the remote host using one of a plurality of different routes between the local host and the remote host, the routing based in part on the modification to the adaptive routing to select the one of the plurality of different routes.

16. The method of claim 15, wherein the event is failed or congested link in the different routes between the local host and the remote host, the failed or congested link to cause the change in the network bandwidth between the local host and the remote host.

17. The method of claim 15, wherein the routing protocols is associated with a Border Gateway Protocol (BGP) that enables communication of the event between the at least one switch and other switches in the network communication.

18. The method of claim 15, further comprising:
converting, using a conversion feature of the routing protocols, the event to weighting values; and
performing the modification of the adaptive routing using a modification feature of the routing protocols that uses the weighting values in an algorithm associated with the adaptive routing.

19. The method of claim 15, further comprising:
receiving instructions through an interface associated with the at least one switch;
enabling the determination of the event associated with the change in network bandwidth based in part on the instructions; and
enabling a determination of the routing protocols for the network communication.

20. The method of claim 15, further comprising:
determining the at least one switch based in part on a predetermined hop distance from the remote host, the at least one switch comprising an adaptive routing algorithm;
receiving the event in a communication to the at least one switch from the remote host; and
removing at least one of a plurality of next-hops to the remote host, as part of the routing protocols, based in part on the communication to provide the modification of the adaptive routing in the at least one switch.
